(19) United States
(12) Patent Application Publication
(10) Pub. No.: US 2008/0311343 A1
(43) Pub. Date: Dec. 18, 2008

(54) Highly Resilient, Dimensionally Recoverable Nonwoven Material

(76) Inventors: Larry L. Kinn, East Longmeadow, MA (US); Rui B. Ferreira, Longmont, CO (US); Clement J. Haley, Mifflinburg, PA (US); Raymond A. D'Amato, Enfield, CT (US)

Correspondence Address: ALIX YALE & RISTAS LLP, 750 MAIN STREET, SUITE 1400, HARTFORD, CT, 06103, US

(21) Appl. No.: 11/913,979

(22) PCT Filed: May 9, 2006
(86) PCT No.: PCT/US06/17990

§ 371 Date: May 27, 2008

Related U.S. Application Data
(60) Provisional application No. 60/679,713, filed on May 11, 2005.

(51) Int. Cl. B32B 3/10; D04H 13/00; D04H 5/02

(52) U.S. Cl. 428/137; 442/329; 28/104

(57) ABSTRACT

A microcreped wet laid nonwoven with recoverable stretch suitable for apparel applications such as waistbands and interlinings. The microcreping and heat setting improves dimensional stability after washing and drying cycles, minimizes shrinkage and substantially eliminates the surface wrinkling phenomenon, known in the industry as “alligatoring”, associated with wet laid and other apparel nonwovens.

### BACKGROUND OF THE INVENTION

Wet laid nonwoven fabrics are widely used in apparel applications for many interlining and interfacing end uses. Wet laid nonwoven fabrics offer more dimensional stability and uniform properties in all directions than other types of nonwoven fabrics such as carded webs. However, wet laid nonwoven fabrics have only a very limited ability to stretch, typically, about 10 percent to 15 percent in the MD and 20 percent in the CD before breaking. Stretching in a wet laid nonwoven fabric is due to fiber separation and deformation of binder, if present. Stretching in a wet laid nonwoven fabric is non-elastic, thus a wet laid nonwoven fabric that is stretched 10 percent (to 110 percent of its original length) will remain at the 110 percent length when tension is removed. Thus, the use of wet laid nonwoven fabrics is limited in some applications, such as use in pant waistbands, where a certain amount of elastic or recoverable stretch in the machine direction is desirable. Due to the limited recoverable machine direction stretch in nonwovens, the apparel industry has had to use expensive solutions for waistband linings such as using woven fabrics cut on a 45-degree bias, using knit fabrics, using webs composed of continuous elastomeric fibers, using elastomeric films, using various micro-webs, or employing complicated waistband designs with overlapping fabric segments allowing for slip. Another approach to render nonwoven webs stretch recoverable in the machine direction is to crepe or microcrepe the nonwoven. In creping, the nonwoven web is adhered to a creping surface and removed from the surface through the use of a doctor blade. In microcreping the stretch recoverable properties of the nonwoven web are obtained by a combination of retarding and compressing the web during its travel on and removal from a roll as detailed in U.S. Pat. No. 3,260,778 issued to Walton and further refined in other patents since, such as U.S. Pat. No. 4,717,329 issued to Packard et al.

After repeated washing and drying cycles the surface of a wet laid nonwoven web will undesirably deteriorate and roughen. This rough surface appearance is attributed to discontinuous surface wrinkles and is referred to the in apparel industry as either “elephant skin” or “alligatoring”. This surface deterioration also limits use of wet laid nonwoven webs.

Nevertheless, in spite of these advancements the apparel market continues to seek suitable nonwovens with recoverable machine direction stretch in the lightweight range of 1.0 to 5.0 ounces per square yard that have sufficient durability and that do not shrink after normal garment use including washing, drying and dry-cleaning.

### DEFINITIONS

Bicomponent fiber or filament—Conjugate fiber or filament that has been formed by extruding polymer sources from separate extruders and spun together to form a single fiber or filament. Typically, two separate polymers are extruded, although a bicomponent fiber or filament may encompass extrusion of the same polymeric material from separate extruders. The extruded polymers are arranged in substantially constantly positioned distinct zones across the cross-section of the bicomponent fibers or filaments and extend substantially continuously along the length of the bicomponent fibers or filaments. The configuration of bicomponent fibers or filaments can be symmetric (e.g., sheath:core or side:side) or they can be asymmetric (e.g., offset core within sheath; crescent moon configuration within a fiber having an overall round shape). The two polymer sources may be present in ratios of, for example (but not exclusively), 75/25, 50/50 or 25/75.

Biconstituent fiber—A fiber that has been formed from a mixture of two or more polymers extruded from the same spinneret. Biconstituent fibers do not have the various polymer components arranged in relatively constantly positioned distinct zones across the cross-sectional area of the fiber and the various polymers are usually not continuous along the entire length of the fiber, instead usually forming fibrils which start and end at random. Biconstituent fibers are sometimes also referred to as multiconstituent fibers.

Calendering—the process of smoothing the surface of the paper by pressing it between opposing surfaces. The opposing surfaces include flat platens and rollers. Either or both of the opposing surfaces may be heated.

Cellulose material—A material comprised substantially of cellulose. Cellulosic fibers come from manmade sources (for example, regenerated cellulose fibers or lyocell fibers) or natural sources such as fibers or pulp from woody and non-woody plants. Woody plants include, for example, deciduous and coniferous trees. Non-woody plants include, for example, cotton, flax, esparto grass, sisal, abaca, milkweed, straw, jute, hemp, and bagasse.

Conjugate fiber or filament—Fiber or filament that has been formed by extruding polymer sources from separate extruders and spun together to form a single fiber or filament. A conjugate fiber encompasses the use of two or more separate polymers each supplied by a separate extruder. The extruded polymers are arranged in substantially constantly positioned distinct zones across the cross-section of the conjugate fiber or filament and extend substantially continuously along the length of the conjugate fiber or filament. The shape of the conjugate fiber or filament can be any shape that is convenient to the producer for the intended end use, e.g., round, trilobal, triangular, dog-boned, flat or hollow.

Creping and microcreping—A process that compacts a nonwoven web in the machine direction such that a series of small, generally discontinuous parallel folds are imparted to the web. Microcreping differs from creping primarily in the size of the imparted folds.

Cross machine direction (CD)—The direction perpendicular to the machine direction.

Denier—A unit used to indicate the fineness of a filament given by the weight in grams for 9,000 meters of filament. A filament of 1 denier has a mass of 1 gram for 9,000 meters of length.

Drape—The ability of material to hang in loose or limp folds.

Fiber—A material form characterized by an extremely high ratio of length to diameter. As used herein, the terms fiber and filament are used interchangeably unless otherwise specifically indicated.

Filament—A substantially continuous fiber. As used herein, the terms fiber and filament are used interchangeably unless otherwise specifically indicated.

Hardwood pulps—Any fibrous materials of deciduous tree origin, which have been reduced to their component elements either through mechanical means, such as pulp grinders, or chemically by the use of various type of cooking liquors, usually under high temperature and pressure. Deciduous trees include, for example, alder, birch, eucalyptus, oak, poplar, sycamore, sweetgum and walnut.

Heat setting—A process employing heat and pressure on a substrate to accomplish certain desired results. On fabrics made of synthetic fiber (or of natural, chemically treated fibers), heat setting is used to prevent shrinkage or to impart a crease or pleat that will last through washings or dry cleanings.

Lyocell—Manmade cellulose material obtained by the direct dissolution of cellulose in an organic solvent without the formation of an intermediate compound and subsequent extrusion of the solution of cellulose and organic solvent into a coagulating bath.

Machine direction (MD)—The direction of travel of the forming surface onto which fibers or filaments are deposited during formation of a nonwoven web material.

Meltblown fiber—A fiber formed by extruding a molten thermoplastic material as filaments from a plurality of fine, usually circular, die capillaries into a high velocity gas (e.g., air) stream which attenuates the filaments of molten thermoplastic material to reduce their diameter. Thereafter, the meltblown fibers are carried by the high velocity gas stream and are deposited on a collecting surface to form a web of randomly dispersed meltblown fibers. Meltblown fibers are generally continuous. The meltblown process includes the meltspray process.

Natural fiber pulps—Any fibrous materials of non-woody plant origin, which have been reduced to their component elements either through mechanical means, such as pulp grinders, or chemically by the use of various type of cooking liquors, usually under high temperature and pressure. Non-woody plants include, for example, cotton, flax, esparto grass, sisal, abaca, milkweed, straw, jute, hemp, and bagasse.

Non-thermoplastic polymer—Any polymer material that does not fall within the definition of thermoplastic polymer.

Nonwoven fabric, sheet or web—A material having a structure of individual fibers which are interlaid, but not in an identifiable manner as in a woven or knitted fabric. Nonwoven materials have been formed from many processes such as, for example, meltblowing, spunbonding, carding and wet laying processes. The basis weight of nonwoven fabrics is usually expressed in grams per square meter (gsm).

Polymer—A long chain of repeating, organic structural units including thermoplastic and non-thermoplastic polymers. Generally includes, for example, homopolymers, copolymers, such as for example, block, graft, random and alternating copolymers, terpolymers, etc, and blends and modifications thereof. Furthermore, unless otherwise specifically limited, the term “polymer” includes all possible geometrical configurations. These configurations include, for example, isotactic, syndiotactic and random symmetries.

Regenerated cellulose—Manmade cellulose obtained by chemical treatment of natural cellulose to form a soluble chemical derivative or intermediate compound and subsequent decomposition of the derivative to regenerate the cellulose. Regenerated cellulose includes spun rayon and regenerated cellulose processes include the viscose process, the cuprammonium process and saponification of cellulose acetate.

Softwood pulps—Any fibrous materials of coniferous tree origin, that have been reduced to their component elements either through mechanical means, such as pulp grinders, or chemically by the use of various type of cooking liquors, usually under high temperature and pressure. Coniferous trees include, for example, cedar, fir, hemlock, pine and spruce.

Spunbond filament—A filament formed by extruding molten thermoplastic materials from a plurality of fine, usually circular, capillaries of a spinneret. The diameter of the extruded filaments is then rapidly reduced as by, for example, educative drawing and/or other well-known spunbonding mechanisms. Spunbond fibers are generally continuous with deniers within the range of about 0.1 to 5 or more.

Spunbond nonwoven web—Webs formed (usually) in a single process by extruding at least one molten thermoplastic material as a plurality of filaments from a plurality of fine, usually circular, capillaries of a spinneret. The filaments are partly quenched and then drawn out to reduce fiber denier and increase molecular orientation within the fiber. The filaments are generally continuous and not tacky when they are deposited onto a collecting surface as a fibrous batt. The fibrous batt is then bonded by, for example, thermal bonding, chemical binders, mechanical needling, hydraulic entanglement or combinations thereof, to produce a nonwoven fabric.

Staple fiber—A fiber that has been formed at, or cut to, staple lengths of generally one quarter to eight inches (0.6 to 20 cm).

Substantially continuous—in reference to the polymeric filaments of a nonwoven web, it is meant that a majority of the filaments or fibers formed by extrusion through orifices remain as continuous unbroken filaments as they are drawn and then impacted on the collection device. Some filaments may be broken during the attenuation or drawing process, with a substantial majority of the filaments remaining intact over the length of the sheet.

Synthetic fiber—a fiber comprised of manmade material, for example glass, a polymer or combination of polymers, metal, carbon, regenerated cellulose and Lyocel.

Tex—A unit used to indicate the fineness of a filament given by the weight in grams for 1,000 meters of filament. A filament of 1 tex has a mass of 1 gram for 1,000 meters of length.

Thermoplastic polymer—A polymer that is fusible, softening when exposed to heat and returning generally to its unsoftened state when cooled to room temperature. Thermoplastic materials include, for example, polyvinyl chlorides, some polyesters, polyamides, polyfluorocarbons, polyolefins, some polyurethanes, polystyrenes, polyvinyl alcohol, copolymers of ethylene and at least one vinyl monomer (e.g., poly (ethylene vinyl acetates), and acrylic resins.

### SUMMARY OF THE INVENTION

It has been found that microcreping wet laid nonwoven webs in combination with heat setting can achieve the desirable properties of a low energy recoverable machine direction stretch, in-use durability, and still exhibit overall good isotropic properties.

One embodiment of the invention comprises a method of forming an elastic nonwoven web having low energy recoverable machine direction stretch, in-use durability and good isotropic properties. The method comprises providing a plurality of synthetic staple fibers; dispersing the staple fibers in a fluid to form a furnish; depositing the furnish over a foraminous member; withdrawing fluid from the deposited furnish through the foraminous member to form a wet laid nonwoven web; microcreping the wet laid nonwoven web to a compaction in the range of about 10 percent to about 50 percent to form a compacted nonwoven web; and heating during microcreping the compacted nonwoven web to form the elastic nonwoven web.

It has been further discovered that the rough surface associated with wet laid nonwovens after repeated washing and drying cycles can be eliminated altogether by microcreping under heat the wet laid nonwoven.

Another embodiment of the invention comprises a method of improving the resistance of a surface of a nonwoven web to roughening caused by washing and drying cycles. The method comprises providing a plurality of synthetic staple fibers; dispersing the staple fibers in a fluid to form a furnish; depositing the furnish over a foraminous member; withdrawing fluid from the deposited furnish through the foraminous member to form a wet laid nonwoven web; microcreping the wet laid nonwoven web to a compaction in the range of about 10 percent to about 50 percent to form a compacted nonwoven web; and heating during microcreping the compacted nonwoven web to form the elastic nonwoven web.

In general, the compositions of the invention may be alternately formulated to comprise, consist of, or consist essentially of, any appropriate components herein disclosed. The compositions of the invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

When the word “about” is used herein it is meant that the amount or condition it modifies can vary some beyond that so long as the advantages of the invention are realized. The skilled artisan understands this and expects that the disclosed results of the invention might extend, at least somewhat, beyond one or more of the limits disclosed. Later, having the benefit of the inventors disclosure and understanding the inventive concept and embodiments disclosed including the best mode known to the inventor, the inventor and others can, without inventive or undue effort, explore beyond the limits disclosed to determine if the invention is realized beyond those limits and, when embodiments are found to be without any unexpected characteristics, those embodiments are within the meaning of the term about as used herein.

A better understanding of the invention will be obtained from the following detailed description of the presently preferred, albeit illustrative, embodiments of the invention.

### DETAILED DESCRIPTION

In one embodiment a nonwoven web or sheet is made by a wet papermaking process. The wet laid nonwoven web is preferably formed as a single layer, but two or more distinct layers may be simultaneously formed depending on the end use requirements. Once formed the wet laid nonwoven web is microcreped in the machine direction to a compaction of at least about 10 percent, heated and cooled. The wet laid nonwoven web may be compacted and heated at the same time.

An advantageous wet laid nonwoven sheet is comprised of a mixture of synthetic, short, staple fibers; cellulosic material and binder for a final combined weight in the range of 0.8 to 5 ounces per square yard (27-153 g/m²). In one variation the wet laid nonwoven web comprises 10 to 80 percent synthetic, short, staple fibers, with the remainder being cellulosic material comprising natural softwood pulp, natural hardwood pulp, natural fibers or combinations thereof.

The preferred synthetic short staple fibers are polyester, such as poly(ethylene terephthalate) (“PET”), from 1 to 15 denier, with about 1.5 denier preferred, with a fiber length in the range of 0.25 to 0.75 inch (6-20 mm), with 0.50 inch preferred. Other suitable materials for making short staple fibers are believed to include, but are not limited to, acrylic, polyolefin, polyamide, Lyocell® and rayon. Mixtures of different fiber materials and different fiber diameters or lengths may also be used. Naturally, the fibers chosen will influence the compaction temperature used during the microcreping process.

The cellulosic material can be selected from substantially any class of pulp, fibers and blends thereof. Preferably the cellulosic material is characterized by being entirely natural, cellulosic fibers and can include wood fibers as well as cotton and plant fibers, although softwood papermaking pulps, such as spruce, fir, hemlock, cedar and pine are typically employed in combination with hardwood papermaking pulps. Hardwood pulps include, but are not limited to sweetgum, oak, sycamore, eucalyptus, alder, poplar, walnut and birch. Non-wood pulps and/or fibers, such as sisal, kenaf, abaca and others may also be used, as can mixtures of different natural pulps and natural fibers. The natural pulp may constitute up to about 76% of the finished product weight, accounting for the fiber and binder components.

Some embodiments may optionally comprise fibrillar materials formed from polymers and commonly referred to as “synthetic pulp”. Synthetic pulp used in these embodiments can replace some or all of the cellulosic material and be used in amounts of about 20 percent to about 90 percent of the finished wet laid nonwoven sheet weight. Synthetic pulp exhibits a fibrilliform morphology and a resultant high specific surface area. Synthetic pulp is readily dispersible in water without the need for additional surface active agents and, although hydrophobic in nature, does not dewater as rapidly as synthetic short staple fibers. Synthetic pulp does not exhibit the tendency to “float out” in chests and holding tanks used in the typical wet paper-making process. Thus, synthetic pulp can have characteristics including high specific surface area, water insensitivity, low density and small particle size. Synthetic pulp is typically comprised of a thermoplastic polymer such as polyolefin or some polyamides and having a structure resembling wood pulp. That is, the synthetic pulp has a micro-fibrillar structure comprised of micro-fibrils exhibiting a high surface area as contrasted with the smooth, rod-like morphology of synthetic short staple fibers. The synthetic pulp can be dispersed to achieve excellent random distribution in a wet process furnish and, consequently, can achieve excellent random distribution within the resultant wet laid sheet product. One particularly advantageous synthetic pulp is comprised of high density polyolefins of high molecular weight and low melt index.

The fibrils can be formed under high shear conditions in an apparatus such as a disc refiner or can be formed directly from their monomeric materials. Patents of interest with respect to the formation of fibrils are: U.S. Pat. Nos. 3,997,648, 4,007,247 and 4,010,229. As a result of these processes, the resultant synthetic pulp dispersions are comprised of fiber-like particles having a typical size and shape comparable to the size and shape of natural cellulosic fibers. The synthetic pulp particles exhibit an irregular surface configuration, can have a surface area in excess of one square meter per gram, and may have surface areas of even 100 square meters per gram. The fiber-like particles exhibit a morphology or structure that comprises fibrils which in turn are made up of micro-fibrils, all mechanically inter-entangled in random bundles generally having a width in the range of 1 to 20 microns. In general, the pulp-like fibers of polyolefins such as polyethylene, polypropylene, and mixtures thereof have a fiber length well suited to the paper-making technique, e.g., in the range of 0.4 to 2.5 millimeters with an overall average length of about 1 to 1.5 millimeters.

The synthetic short staple fibers, natural pulp and optionally synthetic pulp and/or binder fibers are dispersed in a fluid to form a furnish. Typically, the fluid is aqueous. The furnish may optionally contain other components. For example, the furnish may comprise up to 2 percent by fiber weight, advantageously about 1.5% by fiber weight, of a wet-strength additive. The wet strength additive provides limited strength to the wet laid nonwoven web prior to drying. The furnish is deposited on a foraminous member such as, for example, a mesh belt or wire of a papermaking machine, in a manner known in the art. The synthetic short staple fibers, cellulosic material and, if present, binder are deposited on the moving belt while the dispersing fluid moves through the belt. A vacuum source may be provided under the belt to help move the dispersing fluid through the belt. As the furnish is dewatered on the moving belt a continuous sheet-like web of generally randomly dispersed fibers is formed.

The wet laid nonwoven web is subjected to a conventional drying step to reduce water present in the deposited web materials. The drying step may comprise vacuum drying, passage of the nonwoven web around heated drying cylinders, passage of the nonwoven through heated dryers or combinations of the above.

Properties of the dried, wet laid nonwoven web can be enhanced by the addition of a suitable binder. Suitable binders can include both the resin binders such as the acrylics, vinyl acetates, polyesters, polyvinyl alcohols, and other traditional binder families; as well as synthetic binder fibers. Synthetic binder fibers commonly used are the polyvinyl alcohols and the many bicomponent, temperature active fibers such as polyolefin and polyesters.

The binder content is in the range of 15 to 35 weight percent of the final product, with the higher end of that range being advantageous, such as 20 to 30%, with about 24% being preferred. This range can be achieved by using exclusively resin binders or synthetic binder fibers, or a combination of resin binder with synthetic binder fibers. The currently preferred binder chemistries are acrylics designed specifically for apparel applications to withstand the rigors of fabric washing, drying and dry-cleaning.

Synthetic binder fibers are typically blended into the fiber furnish prior to deposition on the foraminous member. When the wet laid nonwoven web is heated and cooled the binder fibers partially melt and fuse to adjacent fibers to bind the fibers in the web. A resin binder is typically added as an aqueous solution to the deposited web prior to drying by common chemical methods such as size-press, curtain coater, spray coater, foam coater and wet-end addition.

The wet lay process provides a generally bonded nonwoven web, e.g. a web wherein the fibers have sufficient entanglement and cohesion that the web will remain intact without further bonding processes. Thus, some embodiments do not require and do not use additional processes to entangle the fibers comprising the web, for example hydroentanglement, and thereby bond the nonwoven web, either before or after compaction. Elimination of the additional entanglement process is an advantage of the disclosed embodiments over nonwoven production methods that require such additional processes.

After the wet laid nonwoven sheet has been formed, optionally treated with binder and dried it is then conveyed to a microcreping process. The inventors believe that the exemplified microcreping process follows the general principles of microcreping, in particular the combination of retarding and compressing the wet laid nonwoven sheet during its travel on and removal from a roll to form a series of small, generally parallel folds in wet laid nonwoven web. The troughs and peaks of the folds generally extend in the cross machine direction, e.g. generally transversely to the machine direction. One provider of compaction systems is Micrex Corporation of Walpole Mass.

The wet laid nonwoven sheet is compacted in the range of about 10 to about 50 percent and preferably in the range of about 20 to about 30 percent. During compaction the wet laid nonwoven sheet is heated to a temperature suitable to heat set the fibers comprising the compacted web. For example, a wet laid nonwoven sheet comprising polyester synthetic fibers can be heated during compaction to a temperature in the range of 300 to 425 F, and preferably to a minimum to 350 F, to heat set the compacted sheet. While visible, the folds defining the creping pattern are fine enough that there is no difference between the surface feel of the wet laid nonwoven web before and after the microcreping process. Surprisingly, the microcreping process can improve the wet laid nonwoven sheet's overall drape and also introduces recoverable machine direction stretch. Microcreping the wet laid nonwoven sheet to Micrex Corporation specification number C2715 has been found suitable for use.

Having generally described the invention, the following examples are included for purposes of illustration so that the invention may be more readily understood and are in no way intended to limit the scope of the invention unless otherwise specifically indicated.

### EXAMPLES

Prototype webs were made and tested for suitability in apparel applications using combinations of the following ingredients.

Northern softwood pulp, obtained from black spruce trees, and supplied by the Irving Pulp & Paper Ltd., located in Saint John, New Brunswick, Canada.

South American hardwood pulp, obtained from eucalyptus trees, and supplied by Aracruz Celulose, with main offices located in Sao Paulo, Brazil.

Polyester (PET) staple fibers labeled as T103, and supplied by Invista Inc., of Salisbury, N.C.

Aqueous acrylic emulsion binders, labeled as type Rhoplex E32NP with a Tg of +5° C. and type Rhoplex TR407 with a Tg of +34° C.; both supplied by Rohm and Haas Company with main offices located in of Philadelphia, Pa.

The prototype samples were then tested using the following techniques.

Basis weight was performed according to the TAPPI test procedure T410.

Sample Thickness was measured according to TAPPI test procedure T411.

Elmendorf Tear strength was measured according to TAPPI test procedure T414.

Tensile strength and elongation at break testing were performed according to the TAPPI test procedure T494 using a Zwick Tensile Tester, model Z2.5. Grab Tensile testing used samples 4-inch wide by 6-inch in length, with a cross-head speed of 12-inch per minute; jaw span of 3-inch and constant rate of extension. Strip Tensile testing used samples 1-inch wide by 12 inch long, with a cross-head speed of 1-inch per minute; jaw span of 5-inch and a constant rate of extension.

Samples were washed in a typical laundry cycle and dried to establish their appearance, percent shrinkage and percent of recovery stretch performance. The wash cycle was performed with a Whirlpool clothes washer model LFA 5700; normal wash cycle setting, using the medium (warm) water setting for a period of six minutes. Water temperature was measured as being about 108 degrees Fahrenheit. The wash was agitated at 58 strokes per minute followed by two spin cycles with a rinse cycle in between. The first spin cycle was at 340 rpm, and the final spin cycle was 515 rpm. The samples used for washing and drying were 11-inches in machine direction length and 8.5-inches in cross machine direction length. The samples were washed in combination with two medium sized cotton laboratory coats used as ballast. Twenty milliliters of concentrated Tide fabric detergent were used during each washing cycle.

The drying of samples was performed in a Whirlpool clothes dryer model LAE 5700W0, using a heat setting of 185 degrees Fahrenheit, for 30 minutes. The samples were also dried in combination with two medium sized cotton laboratory coats used as ballast. Wash shrinkage was conducted after three separate wash and drying cycles. Samples were measured for machine direction length and cross machine direction length before and after the three cycles. Percent shrinkage was calculated as (initial length−final length)/(initial length)×100.

Sample appearance was established after washing and drying by a visual test conducted by a panel of five individuals with the following scale rating: 0=no surface pattern, 2=minimum surface pattern, 4=medium surface pattern, 6=heavy pattern. The surface pattern consisted of wrinkles or discontinuities, or small folds in the surface appearance.

Cyclic tensile testing, using the Zwick Tensile Tester, model Z2.5, was conducted to establish the degree of recovery stretch. The samples were cut to 2-inch wide by 12 inch in length and conditioned according to TAPPI T494. The samples were mounted on 3-inch wide rubber faced jaws using a jaw span of 10-inches, and a cross-head speed of 10-inch per minute. The tensile tester was programmed to stretch the samples to different lengths, as noted, for ten cycles each elongation setting. For each of the ten cycles, the samples were extended to the predetermined level of their original length, held in extension for 15 seconds, and returned to its original position (0% elongation or 10-inches). After the tenth cycle the sample was removed from the jaws and measured for overall length. The percent stretch recovery was calculated as (initial length/final length)*100.

Percent of hot air shrinkage of samples was established by conditioning the samples to a temperature of 325 degrees Fahrenheit for 15 minutes, using a Grieve & Henry convection oven, and measuring the length in the machine and cross machine direction before and after drying. The samples used for hot air drying were 11-inches in machine direction length and 8.5-inches in cross machine direction length. Samples were hung in the machine direction attached by clips to a horizontal fixture located at a medium height of the oven interior. The percent shrinkage was calculated as (initial length−final length)/(initial length)*100. This test mimics typical temperature conditions used for processing wrinkle-free fabrics.

### Example 1

This example shows the effect that microcreping, according to specification number C2715 process, has on product appearance, shrinkage and recovery stretch. Accordingly, a wet laid nonwoven was prepared using an inclined wire paper making machine from a fiber furnish consisting of 40% 1.5 denier by 0.5 inch T-103 type polyester fibers; 20% 15.0 denier by 0.75 inch T-103 type polyester fibers, 10% Aracruz eucalyptus wood pulp and 30% Irving softwood pulp. After formation, the nonwoven web was treated with an acrylic binder, type TR407 from Rohm & Haas, to achieve a binder content of about 24% of the overall final weight. The material was dried and accumulated after binder treatment. The overall material basis weight was 88.5 grams per square centimeter (g/m²) and labeled as sample 100. Sample material 100-M is sample 100 material after being processed through the Micrex Corporation microcreping process to specification number C2715. Representative data for the wet laid nonwoven and its microcreped version are summarized below in table. The table also includes a nonwoven used in waistband applications produced according to the procedures detailed in U.S. Pat. No. 6,375,889 issued to Holmes et al. This product is identified in Table 1 as SBR2000-7-61-IY.

TABLE 1

| Sample | | 100 | 100 - M | SBR2000-7-61-IY |
|---|---|---|---|---|
| Basis weight | g/m² | 88.5 | 112 | 210 |
| Degree of Compaction | % | none | 25 | Not known |
| Compaction Temperature | ° F. | n/a | 350 | Not known |
| Thickness | μm | 430 | 485 | 900 |
| MD Dry Tensile @ break | g/25 mm | 5550 | 6350 | 38000 |
| CD Dry Tensile @ break | g/25 mm | 4050 | 6100 | 24300 |
| MD Tensile @ 10% stretch | g/50 mm | 12,000 | 550 | 2275 |
| MD Recovery @ 10% stretch | % | broke | 99 | 99 |
| MD Elmendorf Tear | grams | 415 | 765 | 1600 |
| CD Elmendorf Tear | grams | 535 | 880 | 1600 |
| MD Hot Air Shrinkage | % | 0.85 | 0 | 10.7 |
| CD Hot Air Shrinkage | % | 0 | 0 | 8.5 |
| MD Wash Shrinkage | % | 1.42 | 0 | 10.4 |
| CD Wash Shrinkage | % | 1.47 | 0 | 8.5 |
| Surface Appearance | Rating | 2 | 0 | 0 |

The data show that microcreping the wet laid nonwoven web according to specification number C2715 is effective in eliminating the rough surface appearance associated with wet laid nonwovens after washing and drying. Product shrinkage attributed to hot air drying or washing combined with drying has also been eliminated by this microcreping process as exhibited in the sample 100-M shrinkage data. The microcreped sample demonstrates the ability to have 99 percent recovery stretch when extended by 10% of its initial length, whereas the original wet laid nonwoven, sample 100, broke before achieving 10% elongation. The competitive nonwoven product exhibits poor shrinkage performance overall, with shrinkage results greater than the acceptable industrial standard of 3% for machine direction (MD) and cross machine direction (CD). The wet laid microcreped sample 100-M also requires a lower force to achieve an extension at 10% stretch as compared to the un-microcreped sample 100, and the competitive product, SBR2000-7-61-IY. The lower extension force requirements and recovery are important in, for example, waistband applications, where the ability to stretch and conform should not impose discomfort to the person wearing the garment.

### Example 2

In this example two prototype wet laid nonwovens were prepared by the paper making process as in example 1. The first prototype was made using a fiber composition of 30% 1.5 denier by 0.5 inch T-103 type polyester fibers; 30% 1.5 denier by 0.25 inch T-103 type polyester fibers; 10% Aracruz eucalyptus wood pulp and 30% Irving softwood pulp. After formation, the nonwoven web was treated with an acrylic binder, type TR407 from Rohm & Haas, to achieve a binder content of about 18% of the overall final weight, set at 37 g/m². This nonwoven web was then microcreped resulting in final product weights of 49 g/m² and labeled 101-M. A second prototype wet laid nonwoven was made comprising of 30% 1.5 denier by 0.5 inch T—103 type polyester fibers; 30% 15.0 denier by 0.75 inch T-103 type polyester fibers; 10% Aracruz eucalyptus wood pulp and 30% Irving softwood pulp. After formation, the nonwoven web was treated with an acrylic binder, type E32NP from Rohm & Haas, to achieve a binder content of about 18% of the overall final weight, set at 124 (g/m²), this sample is labeled as 102. The wet laid nonwoven web of sample 102 typically has a MD elongation to break of about 15%, with substantially no recovery, and a CD elongation to break of about 19%, with substantially no recovery. After microcreping at 25% compaction this material weight increased to 155 g/m², this sample is labeled as 102-M. The microcreping process was conducted in two separate ways, first according to specification number C2715, using a heat setting temperature during the process, and secondly without the heat setting conditions, in order to demonstrate the beneficial effects of heat setting. Table 2 exhibits the average machine direction stretch recovery data with and without the use of heat setting during the microcreping process. Different sample specimens were stretched to predetermined levels ranging from 2.5% elongation of original length up to 40% elongation of original length, for ten cycles at each elongation. The force data represent the average tensile force for each cycle.

The results in Table 2 illustrate that without heat setting during the microcreping process the MD stretch is not recoverable after a certain level of elongation. The lightweight sample, 101-M, microcreped without heat setting does not maintain 90% stretch recovery after being extended beyond 15%, whereas the same sample microcreped with heat setting is able to stretch with greater than 90% recovery up until 20% elongation. The heavyweight sample, 102-M, microcreped without heat setting loses its 90% recovery when stretched beyond 10%, and actually broke at this stage of the testing. The heavyweight sample, using heat setting is able to stretch with greater than 90% recovery up until 20% elongation. The force data also illustrate that the ease of extension is better for the samples heat set during the microcreping process, as opposed to higher forces required to stretch the samples to a given elongation, without heat setting.

TABLE 2

| | Sample 101-M | | | | Sample 102-M | | | |
|---|---|---|---|---|---|---|---|---|
| | 49 gsm, 25% compaction | | | | 155 gsm, 25% compaction | | | |
| | No Heat | | Heat set at 325° F. | | No Heat | | Heat set at 390° F. | |
| | Force | | Force | | Force | | Force | |
| Elongation | (g/50 mm) | % Recovery | (g/50 mm) | % Recovery | (g/50 mm) | % Recovery | (g/50 mm) | % Recovery |
| 2.5% | 86 | 99.7 | 95 | 100 | 430 | 97.7 | 460 | 100 |
| 5% | 110 | 97.4 | 157 | 100 | 5800 | 95.8 | 1780 | 100 |
| 7.5% | 170 | 97.4 | 265 | 99.7 | 9817 | 96.2 | 2525 | 99.3 |
| 10% | 170 | 95.2 | 255 | 99.0 | 8700 | 94.9 | 3125 | 98.4 |
| 15% | 280 | 93.2 | 600 | 98.3 | broke | | 4500 | 95.2 |
| 20% | 436 | 87.0 | 1300 | 92.0 | | | 6200 | 91.2 |
| 25% | 750 | 84.3 | 1895 | 88.8 | | | 8325 | 87.7 |
| 30% | 1055 | 81.1 | 2725 | 85.2 | | | 10175 | 84.0 |
| 35% | 1500 | 78.5 | 3350 | 81.7 | | | 11850 | 82.2 |
| 40% | broke | | 4475 | 79.4 | | | broke | |
| 45% | | | broke | | | | | |

### Example 3

In this example the same two nonwoven webs of example 2 processed with microcreping according to specification number C2715 and with and without heat setting were laundered and dried for three washing and drying cycles to establish their appearance and shrinkage performance. The samples were also hot air dried once to establish their heat shrinkage. Table 3 illustrates the shrinkage, appearance and recovery stretch results at 5% elongation for ten stretch cycles.

TABLE 3

| | | Sample 101-M | | Sample 102-M | |
|---|---|---|---|---|---|
| | | 49 gsm, 25% | | 155 gsm, 25% | |
| | | compaction | | compaction | |
| | | | Heat set | | Heat set |
| | | No Heat | at 325° F. | No Heat | at 390° F. |
| MD recovery at 5% | % | 94 | 100 | 93 | 100 |
| stretch after washing | | | | | |
| MD Hot Air | % | (11.5)* | 5.6 | (2.3)* | 0.7 |
| Shrinkage | | | | | |
| MD Wash Shrinkage | % | (12.0)* | 3.8 | (1.7)* | 1.2 |
| CD Wash Shrinkage | % | 2.6 | 0.7 | 1.5 | 1.1 |
| Surface Appearance | rating | 2 | 0 | 4 | 0 |

*these samples actually expanded instead of shrinking in length.

The data illustrates that heat setting during microcreping is also beneficial in providing dimensional stability to the samples after washing and drying cycles. The samples without heat setting also exhibited surface roughening or “alligator” patterning on the surface after the washing and drying cycles. The samples with heat setting did not exhibit surface roughening or “alligator” pattern on the surface.

### Example 4

Constructed waistbands were prepared with the un-microcreped nonwoven web, sample 102, and its microcreped counterpart, sample 102-M, of Example 2 to evaluate their performance in a typical waistband construction. The two nonwoven web samples were first dot-pasted with a co-polyamide hot-melt adhesive with a melting range of 120 to 130° C., designated Griltex-2A, and supplied by EMS-Griltech, of Sumter, S.C. A set of constructed waistbands were prepared by thermally fusing the nonwoven webs to a layer of 205 g/m² polyester woven fabric, itself cut on a 45-degree bias to provide its own stretch. The microcreped nonwoven web, sample 102-M was also fused, then edge folded and stitched to the woven fabric using 10 stitches per inch, to prepare another typical waistband construction. The final width of the three different constructed waistbands was 2-inches. The constructed waistbands were laundered and dried for three wash and drying cycles to establish their appearance and dimensional stability. The samples were also hot air dried once to establish their heat shrinkage. Table 4 illustrates the dimensional stability as well as the recovery stretch performance at 5% elongation, conducted for 100 stretch cycles.

TABLE 4

| | | Constructed waistband with | | |
|---|---|---|---|---|
| | | | Sample 102-M | |
| | | Sample 102 | | Fused and |
| | | Fused only | Fused only | Stitched |
| Adhesive weight | g/m² | 7 | 7 | 7 |
| Nonwoven weight | g/m² | 118 | 155 | 155 |
| Fabric weight | g/m² | 205 | 205 | 205 |
| Waistband weight | g/m² | 330 | 367 | 367 |
| MD recovery at 5% stretch | % | 98.4 | 99.3 | 99.3 |
| Average Load Force at 5% | g/50 mm | 10,485 | 2,880 | 2,635 |
| stretch | | | | |
| MD Hot Air Shrinkage | % | 1.8 | 3.9 | 3.6 |
| MD Wash Shrinkage | % | 0.7 | (0.7)* | (0.7)* |
| Appearance | rating | 5 | 0 | 0 |

*These samples expanded instead of shrinking after the three wash and drying cycles.

The data illustrate that the waistband constructions using the microcreped nonwoven sample 102-M are able to obtain stretch recovery properties at much lower ease of extension when compared to the control un-microcreped waistband construction of sample 102. The surface appearance of the constructed waistband is also superior with the microcreped nonwoven webs.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and scope of the present invention.

What is claimed is:

1. A method of forming an elastic nonwoven web having low energy recoverable machine direction stretch and good isotropic properties comprising:
providing a plurality of synthetic staple fibers and cellulosic material;
randomly dispersing the staple fibers and cellulosic material in a fluid to form a furnish;
depositing the furnish over a foraminous member;
withdrawing fluid from the deposited furnish through the foraminous member to form a wet laid nonwoven web;
microcreping the wet laid nonwoven web to a compaction in the range of about 10 percent to about 50 percent to form a compacted nonwoven web; and
heating the compacted nonwoven web during microcreping to form the elastic nonwoven web.

2. The method of claim 1 wherein the compaction by microcreping is performed on the wet laid nonwoven web without prior fiber entanglement.

3. The method of claim 1 wherein the elastic nonwoven web comprises synthetic pulp.

4. The method of claim 1 wherein the elastic nonwoven web comprises cellulosic material selected from softwood pulps, hardwood pulps, cotton fibers, cotton linters, natural fibers, natural fiber pulps and combinations thereof.

5. The method of claim 1 wherein the elastic nonwoven web comprises cellulosic fibers selected from sisal, abaca, flax, kenaf, jute and henequen.

6. The method of claim 1 wherein the synthetic fibers are polymeric fibers.

7. The method of claim 1 wherein the synthetic fibers are selected from cellulose acetate, nylon, polyolefin, polyester, rayon and combinations thereof.

8. The method of claim 1 wherein the wet laid nonwoven web is comprised of a mixture of cellulosic material and synthetic fibers.

9. The method of claim 1 comprising the step of adding a resin binder to the wet laid nonwoven web.

10. The method of claim 1 wherein the elastic nonwoven web comprises a plurality of synthetic binder fibers that are at least partially thermally fused to the synthetic staple fibers.

11. The method of claim 1 wherein the elastic nonwoven web has a basis weight of about 27 g/m² to about 155 g/m².

12. The method of claim 1 wherein the compacted nonwoven web has a compaction of at least 15 percent.

13. The method of claim 1 wherein the compacted nonwoven web has a compaction of no more than about 45 percent.

14. The method of claim 1 wherein the wet laid nonwoven web is heated to a temperature within the range of about 300 degrees Fahrenheit to about 425 degrees Fahrenheit during microcreping.

15. An article of apparel interlining comprising the elastic nonwoven web made by the method of claim 1.

16. A constructed waistband article comprising the elastic nonwoven web made by the method of claim 1.

17. An embroidery backing article comprising the elastic nonwoven web made by the method of claim 1.

18. A constructed sweat band article used in hats comprising the elastic nonwoven web made by the method of claim 1.

19. A method of improving the resistance of a surface of a nonwoven web to deterioration caused by washing and drying cycles, comprising:
providing a plurality of synthetic staple fibers and cellulosic material;
randomly dispersing the staple fibers and cellulosic material in a fluid to form a furnish;
depositing the furnish over a foraminous member;
withdrawing fluid from the deposited furnish through the foraminous member to form a wet laid nonwoven web;
microcreping the wet laid nonwoven web to a compaction in the range of about 10 percent to about 50 percent to form a compacted nonwoven web; and
heating the compacted nonwoven web to form the elastic nonwoven web.

20. The method of claim 19 wherein the compaction by microcreping is performed on the wet laid nonwoven web without prior fiber entanglement.

21. The method of claim 19 wherein the elastic nonwoven web further comprises cellulosic material selected from softwood pulps, hardwood pulps, cotton fibers, cotton linters, natural fibers, natural fiber pulps and combinations thereof.

22. The method of claim 19 wherein the elastic nonwoven web comprises a plurality of polymeric fibers that are at least partially thermally fused to the synthetic staple fibers.
